(19) United States
(12) Patent Application Publication
(10) Pub. No.: US 2024/0324625 A1
(43) Pub. Date: Oct. 3, 2024

(54) IMPROVED SYSTEM FOR PRODUCTION OF MEAT ANALOGUE PRODUCTS

(71) Applicant: SOCIETE DES PRODUITS NESTLE S.A., Vevey (CH)

(72) Inventors: YOGESH HARSHE, Lausanne (CH); OLIVIER BRETON, Rueyres (CH); PATRICK PIBAROT, Taponnat-Fleurignac (FR); ELISABETH HOEGG, Konstanz (DE); REINHOLD WILLY BETZ, Gottmandingen (DE); BHASKAR MITRA, St. Ursen (CH)

(21) Appl. No.: 18/575,081

(22) PCT Filed: Jun. 30, 2022
(86) PCT No.: PCT/EP2022/068171

§ 371 Date: Dec. 28, 2023

(30) Foreign Application Priority Data
Jun. 30, 2021 (EP) 21182986.6

(51) Int. Cl. A23J 3/26; A23J 3/16; A23J 3/18; A23J 3/22; A23P 30/20

(52) U.S. Cl. CPC A23J 3/26; A23J 3/16; A23J 3/18; A23J 3/227; A23P 30/20

(57) ABSTRACT

The invention relates to a system for making a meat analogue comprising protein, said system comprising i) a die comprising an insert; a core; and a flow path: wherein the flow path is defined by the insert and the core; and ii) a cooling component comprising a cooling chamber, wherein said cooling component is downstream of the die and the flow path passes through the cooling chamber.

### BACKGROUND

The alternative meat market continues to grow with an ever-increasing demand for meat analogue products driven by health awareness, climate concerns and lifestyle choices. Achieving high quality mimicking of specific types of meat, including appearance, flavour and texture, is an ongoing challenge.

There is a clear need for further improvements to the systems and apparatus used for and methods of manufacturing meat analogue products.

### SUMMARY

When considering the structure and texture of meat, a striking feature is the complex hierarchical and multiscale structure of the muscular tissue, which is composed by protein fibrils of actin and myosin embedded in a collagen-based connective tissue. A key structural characteristic of the protein fibrils is that they may reach several centimeters in length and are responsible for chewiness of the meat.

The present invention provides an improved approach for achieving desirable characteristics in protein compositions produced using extrusion devices, particularly in relation to stability and textural properties.

The present invention relates to a system for making a meat analogue comprising protein, said system comprising i) a die comprising an insert or main body, a core and a flow path, wherein the flow path is defined by the insert and the core, and ii) a cooling component comprising a cooling chamber, wherein said cooling component is downstream of the die and the flow path passes through the cooling chamber.

In an embodiment, the cooling chamber comprises a double-jacket structure providing a flow path through the cooling chamber. In an embodiment, the cooling chamber is a closed-sided cooling chamber.

In an embodiment, the cooling chamber comprises helical or cylindrical cavities in which cooling media is located.

In an embodiment, the core comprises a cylindrical section and a summit end. In an embodiment, the die comprises a die exit, formed by a gap between the core and the insert, and wherein the cooling chamber is downstream of the die exit.

In an embodiment, the die comprises an expansion chamber located between the summit end of the core and the die exit and the cooling chamber is downstream of the expansion chamber.

In an embodiment, the insert comprises a first interior surface and the cone comprises a second interior surface, and the first and second interior surfaces form the flow path and one or both surfaces comprise a channel forming the expansion chamber.

In an embodiment, the system further comprises a transition plate and/or a breaker plate upstream of the die.

In an embodiment, the die exit is circular and, optionally, the die exit has a gap size of between 3 mm to 5 mm including 3.3 mm or 4.8 mm. In an embodiment the ratio of the gap size of the die exit to the gap size of the cooling component entry is 1:2 or less, including 1:1.

In an embodiment, the core is moveable, preferably in a single vector, with respect to the insert. Preferably, the core is a conic core with a circular symmetry.

In an embodiment, the die is a short die. Preferably, the die is a coat-hanger type die.

In an embodiment, the die further comprises a frame connected to the insert and the core.

In an embodiment, the frame further comprises positioning means, for example a screw system. The positioning means positions the core inside the insert.

In an embodiment, the frame further comprises a guiding means, for example a screwthread, to facilitate the movement of the core inside the insert. Preferably, the movement of the core by the guiding means is in a single vector.

In an embodiment, the core is not in contact with the insert. Typically, the core is moveable independently of the insert. Typically, there are no structures between the insert and core, for example connecting bridges. These structures would disrupt the flow path of the dough as it passes through the die.

In an embodiment, the insert and the core each further comprise a cooling means. Preferably, the cooling means of the insert is not connected to the cooling means of the core.

In an embodiment, the core comprises a cylindrical section. In an embodiment, the core comprises a summit end. Typically, the angle of the surface at a point between the cylindrical section of the core and the summit end of the core, for example at a point equidistant between the cylindrical section of the core and the summit end of the core is about 135°.

In an embodiment, the core does not rotate in the insert.

The extrudate emerging from the die is particularly well suited to injection of gas, steam, coating, or fat. In an embodiment, the die further comprises one or more complementary rings situated adjacent to the die, preferably between the cooling component downstream of the die and the die exit. Preferably, a complementary ring injects gas, for example nitrogen gas, through a slit, for example a circular slit. Preferably, a complementary ring injects steam through a slit, for example a circular slit. Preferably, a complementary ring injects coating through a slit, for example a circular slit. Preferably, a complementary ring injects fat or fat analog through a slit, for example a circular slit. Preferably, the slit is connected to a pumping system.

The invention further provides a method of making a meat analogue comprising a vegetable protein, the method comprising applying heat and/or pressure to a dough in an extruder; passing the dough through a die that is part of and/or is connected to the extruder, the die comprising an insert, a core, preferably a conic core, and a flow path; wherein the flow path is defined by the insert and the core, and a cooling component comprising a cooling chamber, wherein said cooling component is downstream of the die and the flow path passes through the cooling chamber, wherein the dough passes through the flow path.

In an embodiment, the die is a short die. Preferably, the die is a coat hanger type die.

In an embodiment, gas or steam is injected into the die as the dough passes through the flow path.

In an embodiment, the dough is directed through the flow path at a massic flow rate of greater than 75 kg/h, greater than 100 kg/h, or greater than 300 kg/h.

In an embodiment, the extruder operates at a screwspeed of 50 to 400 rpm.

Preferably, the extruder operates at a temperature of 140° C. to 200° C. The dough can be prepared in a location selected from the group consisting of (i) a mixer from which the dough can be pumped into the extruder and (ii) the extruder, for example by separately feeding powder and liquid into the extruder.

In an embodiment, the method further comprises adjusting the constant temperature of the insert and/or the conic core based on temperature information received from a temperature sensor that senses a temperature of the insert and/or the conic core as the dough passes through the flow path.

The invention further relates to an apparatus comprising i) a die comprising an insert; a core; and a flow path; wherein the flow path is defined by the insert and the core; and ii) a cooling component comprising a cooling chamber, wherein said cooling component is downstream of the die and the flow path passes through the cooling chamber. The preferred embodiments described for the system apply equally to the apparatus.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a cutaway view of an embodiment of a system according to the present disclosure.

FIG. 2 illustrates that cooling the extrudate from 100° C. to 80° C. results in a viscosity increase from 2900 to 3500 Pa·s and in better mechanical resistance.

### DETAILED DESCRIPTION OF EXAMPLE EMBODIMENTS

Detailed embodiments of systems, methods and apparatus are disclosed herein.

However, it is to be understood that the disclosed embodiments are merely exemplary of the systems, methods and apparatus, which may be embodied in various forms. Therefore, specific functional details disclosed herein are not to be interpreted as limiting, but merely as a basis for the claims as a representative example for teaching one skilled in the art to variously employ the present disclosure. Features from system and method embodiments of the invention may be freely combined.

As used herein, the singular forms “a,” “an” and “the” include plural referents unless the context clearly dictates otherwise. For example, reference to “an ingredient” or “a method” includes a plurality of such “ingredients” or “methods.” The term “and/or” used in the context of “X and/or Y” should be interpreted as “X,” or “Y,” or “X and Y.” Similarly, “at least one of X or Y” should be interpreted as “X,” or “Y,” or “both X and Y.”

As used herein, “about,” is understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of

from 20 to 300 should be construed as supporting a range of from 100 to 300, from 200 to 300, from 250 to 300, from 50 to 150, and so forth.

As used herein, “substantially perpendicular direction” should be taken to mean that may include sheared fiber orientations that are about +/−15 degrees from a direction perpendicular to the direction of flow. In some embodiments, fibers that remain substantially perpendicular to the direction of

flow may be bounded by smaller fibers at other angles relative to the direction of flow.
However, even when considering the smaller fibers as included in the sheared fibers, an average angle of the sheared fibers with respect to the direction of flow may remain substantially perpendicular to the direction of
flow. “Substantially equidistant from the inside of the insert” should be taken to mean that greater than 80%, more preferably 90%, most preferably all of the points on the core periphery at the widest diameter of the core are equidistant from the inside of the insert.

All percentages expressed herein are by weight of the total weight of the meat analogue and/or the corresponding emulsion unless expressed otherwise.

The term “conic” refers to the shape of the core. Preferably, the core is a conic core with a circular symmetry. The core may be an alternative shape. Other forms such as an elliptical cone or pyramidal cone with multiple edges, for example greater than six, or seven, or eight, or nine, or ten edges, are also possible.

The terms “food,” “food product” and “food composition” mean a product or composition that is intended for ingestion by an animal, including a human or pet, and provides at least one nutrient to the animal.

A “meat analogue” is a meat emulsion product that resembles meat that has been derived from an animal source, in terms of appearance, texture, and physical structure. The meat derived from an animal source can be, for example, red meat, white meat, and fish. As used herein, a meat analogue

does not include meat derived from an animal source; for example, a meat analogue that lacks meat derived from an animal source may instead use vegetable protein to achieve the appearance, texture, and physical structure of meat derived from an animal source.

A short die is defined as a die in which L/ΠD ratio is less than 1, wherein L is the die length And ΠD is the average exit perimeter. The L/πD ratio defines the length divided by average exit perimeter (πD with D=(d₁+d2)/2). The stresses are applied in the direction and perpendicular to the flow direction of the dough, respectively for L and ID. Typically, the L/ΠD ratio is between 0.1 to 0.99, or about 0.45, or about 0.513, or about 0.53. The length is defined as the length through which a material, for example a dough, travels when the die is in use. The die width is defined as the longest dimension of a planar section of the die through which a material, for example a dough, travels when the die is in use.

In the present context, meat analogues may be plant protein-based food products, which can substitute pieces of meat by mimicking their structure, texture, and taste. A specific feature of meat analogues is the presence of a macroscopic fibrillar protein-based structure.

The preferred embodiments relate to systems, methods and apparatus relating to extruding meat analogues to create a fibrous macrostructure in the meat analogue with a system comprising a cooling chamber downstream of a die. The die of the invention creates meat analogues with fibres which are formed in the die in a substantially perpendicular direction to the flow path of the die.

The system comprises a die comprising an inlet and an outlet, or die exit, and a cooling component comprising a cooling chamber downstream of the die exit. The die is preferably a short die. Preferably, the die is of the coat hanger type.

In one embodiment, the cooling chamber comprises a double-jacket structure comprising water or other cooling media circulating within the structure. The double-jacket structure provides a flow path through the cooling chamber along which a dough or other extruded material may flow after the extruded material has exited the die. The flow path is located between the two jackets of the double-jacket structure. In some examples, the flow path through the cooling chamber may be circular, i.e. a ring shape or annulus. However, in other examples, the flow path may take a different shape. The two jackets may comprise helical, cylindrical or other-shaped cavities in which cooling fluid may be located and/or through which cooling fluid may flow to help control the temperature of the extruded material between the two jackets. The cooling chamber may be regulated by a temperature sensor (not shown). For example, a temperature sensor may be provided on or in one of the walls defining the flow path to measure a temperature of the extruded material in the cooling chamber.

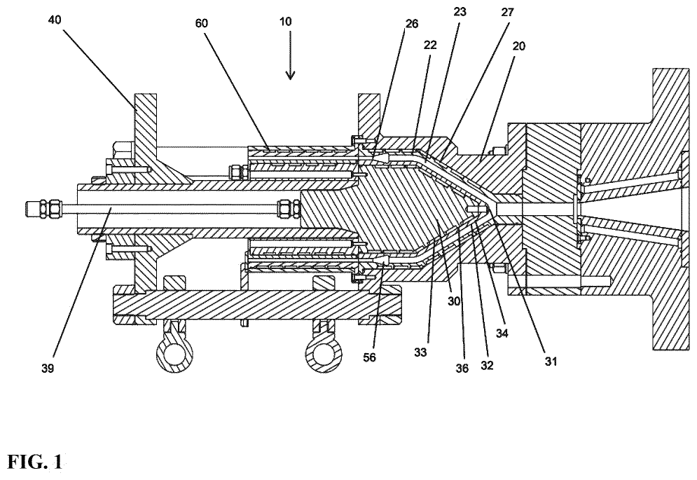

Referring to FIG. 1, the cooling chamber may comprise a double helical mantle 60 having an inlet and an outlet connection to a cooling means. A gap between the conic core and the insert forms the die exit 26. Typically, the die exit is circular. Typically, the die exit has a defined gap size. Typically, the die exit has a gap size of between 1.4 to 4.8 mm, for example 2.5 mm, 3.3 mm or 4.8 mm. Typically, the die exit has an external perimeter of 150 mm, greater than 150 mm, 200 mm, greater than 200 mm and greater than 400 mm, preferably between 150 mm and 500 mm. The gap size at the die exit can be the same size as the annulus or passage through the cooling chamber, or a different size. The ratio of the gap size of the die exit relative to the entry of the cooling chamber annulus or chamber can be 1:2 or less, preferably 1:1. The cooling chamber is downstream of the die exit.

The protein dough may decrease to a temperature of between 70° C. and 80° C. on passing through the cooling chamber downstream of the die. The protein dough may decrease to a temperature of between 10° C. and 60° C. on passing through the cooling chamber downstream of the die.

The system can comprise a transition plate upstream of the die. The transition plate directs the flow of extrudate to the die and controls the temperature of the extrudate before it enters the die. The protein dough can decrease to a temperature of between 55° C. and 110° C. on passing through the transition plate.

The system can alternatively or in addition comprise a breaker plate upstream of the die. The breaker plate may comprise a plurality of holes aligned in the direction of flow. The breaker plate can regulate the flow of extrudate to the die by increasing the pressure at the exit of the extruder.

The die may include a line connection that directs a dough into a die inlet. The line connection may be connected to other elements of a meat analogue production system, for example an extrusion device, to receive raw and/or pre-processed meat analogue and/or dough for processing.

The die and/or cooling component may be manufactured from a metal (i.e., aluminium, stainless steel), a plastic (i.e., Polyethylene Terephthalate, High-Density Polyethylene), an organic material (i.e., wood, bamboo), a composite (i.e., ceramic matric composite), and combinations thereof. The die may be manufactured through extrusion, machining, casting, 3D printing, and combinations thereof. The die may be coated with a material. For example, the die may be coated with a material to prevent bacterial and/or particulate build up inside the die or cooling component.

The die of the invention comprises an insert, also referred to as the main body, a core, preferably a conic core, and a flow path. Preferably, the die comprises means to facilitate movement of the core inside the insert. Referring to FIG. 1, the die 10 comprises an insert or main body 20, and a conic core 30. Frame 40 is connected to the conic core 30 and the insert or main body 20 and facilitates movement of the conic core 30 inside the insert or main body 20. Frame 40 provides a concentric spatial relationship between the conic core 30 and the insert or main body 20.

The flow path is the space between the insert or main body and the core. The insert and the core comprise a first interior surface and a second interior surface, respectively. The first interior surface and the second interior surface define the flow path. The insert and/or core comprise a cooling means. Referring to FIG. 1, the insert 20 and the core 30 include a first interior surface 22 and a second interior surface 32, respectively. The first interior surface 22 and the second interior surface 32 define a flow path 23. The flow path 23 represents the route of the dough as it is directed through the die 10. The insert 20 and/or the core 30 can comprise a cooling means 27, 33, which is in addition to the cooling component of the system that is downstream of the die. The cooling means controls the temperature of the dough as it is directed through the die.

The core may comprise an additional cooling means to control the temperature of the dough. The insert may comprise a cooling means to control the temperature of the dough. Referring to FIG. 1, the cooling means 33 of the core 30 may be controlled independently from the cooling means 27 of the insert 20. Preferably, the cooling means 33 of the core 30 and the cooling means 27 of the insert 20 are not physically connected, for example the coolant or cooling fluid used in the cooling means of the core 30 is not the same coolant or cooling fluid used in the cooling means of the insert 20.

The frame may be connected to the insert by connecting means, for example axes or rods. A positioning means, for example a screw system, may be used to position the core inside the insert. Referring to FIG. 1, the die 10 includes a frame 40. The frame 40 may be connected to the insert 20 by axes. The frame 40 provides a concentric spatial relationship between the core 30 and the insert 20. The frame 40 may include a screw system. The screw system facilitates movement of the core 30 inside the insert 20. The movement may be parallel to a z geometrical axis of the insert 20. The core 30 and the insert 20 may be fixed at any suitable position to form a flow path 23 between the core 30 and the insert 20.

Typically, the core comprises a cylindrical section and a summit end. Typically, the summit end is rounded. The summit end may comprise a helical channel on its surface. A mantle may be adapted to plug on the summit end. This may create a cooling circuit inside the core. The core may be connected to the frame by a central axis. Referring to FIG. 1, the conic core 30 comprises a summit end 31. The summit end 31 is rounded. The summit end 31 has a helical channel 33 on its surface 34. A conic mantle 35 is adapted to plug on the summit end 31 to create a cooling circuit 36 inside the conic core 30 with an inlet connection and an outlet connection to the external cooling. The conic core 30 is connected to the frame by a central axis 39, thereby allowing coolant or cooling fluid to be fed to the conic core cooling circuit 36.

The frame further comprises guiding means, for example a screw thread. This facilitates the accurate positioning of the core inside the insert. The frame and the insert can also be maintained in a fixed position without modification. It also further enables the flow path to be adjusted. The frame 40 may be composed of a bearing guide inside a flange connected to the insert by three screwed rods 45 with an adapted geometry to set the bearing guide centered to the insert. A central axis may be connected on one side to the conic core and on the other side to the bearing guide with fine thread 46 to allow an accurate positioning of the conic core inside the insert and further enables the flow path to be adjusted.

In an embodiment, the die imposes periodic pressure variation on the dough. The conic core can be modified for specific meat analogue applications or to create specific fibrous structures. The first interior surface and the second interior surface may each comprise a channel. The first

interior surface and the second interior surface may each comprise periodical grooves. Referring to FIG. 1, the first interior surface 22 and the second interior surface 32 comprise a channel 56 that acts as an expansion chamber and alternatively compresses and decompresses the atmospheric pressure to create a specific fiber bundle. This expansion chamber is located between the summit end of the core and the slit exit of the die. This process enables mimicking of a fishmeat analogue structure, among other structures. In other applications, the first interior surface 22 and the second interior surface 32 may comprise periodical grooves. These can induce dough flow disturbance to create specific fibrous structures.

In an embodiment, the core comprises a cylindrical section and a summit end. The angle of the surface between the cylindrical section of the core and the summit end of the core can be varied, for example the angle of the surface at a point equidistant between the cylindrical section of the core and the

summit end of the core can be varied. The angle of the surface between the cylindrical section of the core and the summit end of the core, for example the angle of the surface at a point equidistant between the cylindrical section of the core and the summit end of the core, can be between 100° to 170°, or between
110° to 160°, or between 120° to 150°, or between 130° to 140°, or about 135°. Where the angle is 135° or less, the angle of the surface between the cylindrical section of the core and the summit end of the core, for example the angle of the surface at a point equidistant between the cylindrical section of the core and the summit end of the core, can be between 100° to 135°, or between 105° to 130°, or between 110° to 125°, or between 115° to 120°, or about 117º. Where the angle is 135° or more, the angle of the surface between the cylindrical section of the core and the summit end of the core can be between 135° to 170°, or between 140° to 165°, or between 145° to 160°, or between 150° to 155°, or about 152°.

As shown in FIG. 1, the angle of the surface between the cylindrical section of the conic core and the summit end 31 of the conic core 30 can be increased or decreased, thereby adjusting the pressure gradient in the flow path 23. If the angle is decreased, for example to equal or less than 135°, the flow path of the dough will widen at the summit end 31 of the conic core 30 and then the dough will increase in pressure as the flow path 23 is reduced. In another embodiment, if angle is increased, for example to equal or greater than 135°, the flow path of the dough will narrow at the summit end 31 of the

conic core 30 and then the flow of the dough will widen as the flow path 23 is increased. The diameter of the conic core 30 or the distance 51 from the summit end 31 of the conic core 30 to the die entrance is also adjusted when the angle is modified to adjust the gap in the cylindrical section of the conic
core 30. By adjusting the values of the angle, diameter, and distance, the structure and texture of the resulting product at the die exit 26 can be altered. For example, the expansion, density, and fiber organization can be altered.

In an embodiment, the core does not rotate in the insert.

In an embodiment, the die comprises gas or steam injecting means.

In an embodiment, the die further comprises one or more complementary rings situated adjacent to the die, preferably at the die exit and upstream of the cooling component. Preferably, a complementary ring injects gas, for example nitrogen gas, through a slit, for example a circular slit. Preferably, a complementary ring injects steam through a slit, for example a circular slit. Preferably, a complementary ring injects coating through a slit, for example a circular slit. In one embodiment, a complementary ring injects fat or fat analog by means of a circular slit connected to a fat pumping system. In one embodiment, a complementary ring injects ingredients, for example flavor and/or color solutions. If extrusion dies, for example conic dies, are vertically stacked, then multi-structure products can be manufactured. Each complementary ring can add a post-extrusion process step. The process step sequence can be in a different order from herein described depending on the targeted product structure and properties. One or more complementary rings can be situated adjacent to the die exit 26. Internal rings can be attached to the central axis 39. External rings can be maintained in position by three external axes. A fat analogue may be injected using complementary rings situated adjacent to the die exit and upstream of the cooling component comprising the cooling chamber. The complementary rings can be placed immediately adjacent to the die exit and then the cooling chamber can be attached downstream of the rings. The friction of the cooling component can improve incorporation of the fat in the extrudate structure and also lowering the temperature can assist the fat analogue setting in the protein matrix.

In one embodiment, a heat treatment is applied outside the die, for example to obtain jellification of fat emulgel, or to sterilize the meat analogue extrudate. The heat treatment can be provided by water or steam circulation, for example in a double jacket ring. In one embodiment, a complementary ring applies steam on the surface of the meat analogue extrudate. In one embodiment, a complementary ring applies a jellifying composition to create a bilayer structure on the external surface of the meat analogue extrudate. The gelling of the solution can be induced by an additional ring to heat the external layer and to provoke external layer reticulation. The bi-layered structure can be cut in one direction to obtain a bi-structure slab.

In one embodiment, a cutting means cuts the meat analogue extrudate as it exits the die at one point to obtain a single piece of extrudate. In one embodiment, the cutting means is located downstream of the cooling component that is itself located downstream of the die end and can cut the meat analogue extrudate in the same direction as the flow path, such that the cylinder shape opens to form one flat piece of extrudate. In one embodiment, the cutting means cuts the meat analogue extrudate as it exits the die at more than one point to obtain more than one piece of extrudate. In

one embodiment, a cutting means cuts the meat analogue extrudate perpendicularly to the flowing direction with a moving blade to obtain a spring shape. In one embodiment, a cutting means cuts the meat analogue extrudate in both directions to obtain chunks of defined sizes (granulator).

The invention further provides an apparatus comprising i) a die comprising an insert; a core; and a flow path; wherein the flow path is defined by the insert and the core; and ii) a cooling component comprising a cooling chamber, wherein said cooling component is downstream of the die and the flow path passes through the cooling chamber. The die can comprise an expansion chamber located between the summit end of the core and the die exit, where the cooling chamber is downstream of the expansion chamber. The first and second interior surfaces of the insert of the die form the flow path and one or both surfaces comprise a channel forming the expansion chamber.

The invention further provides a method of making a meat analogue comprising a protein, preferably a vegetable protein, the method comprising applying heat and/or pressure to a protein dough in an extruder; passing the dough through a system comprising i) a die comprising an insert; a core; and a flow path; wherein the flow path is defined by the insert and the core; and ii) a cooling component comprising a cooling chamber, wherein said cooling component is downstream of the die and the flow path passes through the cooling chamber. Preferably, the die is a short die of the coat hanger type.

Preferably, the extruder operates at a screw speed of 50 to 400 rpm. The extruder may operate at a massic flow of greater than 20 kg/h, or greater than 75 kg/h, or greater than 100 kg/h, or greater than 200 kg/h, or greater than 300 kg/h, or greater than 1000 kg/h, or up to 5000 kg/h, or up to 100000 kg/h. Preferably, the extruder operates at a temperature of 140° C. to 200° C. The dough can be prepared in a location selected from the group consisting of (i) a mixer from which the dough can be pumped into the extruder and (ii) the extruder, for example by separately feeding powder and liquid into the extruder.

In an embodiment, the method further comprises maintaining the insert, conic core and/or cooling component at a constant temperature.

In an embodiment, the method further comprises adjusting the constant temperature of the insert and/or the conic core based on temperature information received from a temperature sensor that senses a temperature of the insert and/or the conic core as the dough passes through the flow path.

In an embodiment, the method comprises injecting gas or steam into the die as the dough passes through the flow path. Preferably, the gas is nitrogen gas.

In an embodiment, the dough is directed through the flow path at a massic flow rate of 20 kg/h to 300 kg/h, preferably 75 kg/h to 300 kg/h including 150 to 300 kg/h. This may apply to the flow rate through the die and/or the cooling component located downstream of the die.

In an embodiment, the meat analogue comprises fibres which are formed in a substantially perpendicular direction to the flow path of the die. In an embodiment, the values of the ratio of the maximum force to cut the fibres in transversal direction to the maximum force to cut the fibres in longitudinal direction with respect to the direction of the flow path of the die is about 2, more preferably 2 or greater.

In an embodiment, the method further comprising cutting the meat analogue after the meat analogue exits the die. The meat analogue produced according to the system, apparatus and method of the present invention is particularly well suited to cutting product formats such as nuggets, schnitzel and tender, 2D chicken breast formats. The formats can be cutted out using a cutting station, such as an AMF cutter, or the product carpet can be cut in fillet pieces using a cutter, such as HOLAC.

The invention further relates to the use of a system as described herein to make a meat analogue comprising a vegetable protein. Preferably, the invention relates to the use of a system to make a meat analogue comprising a vegetable protein, wherein said die comprises a conic core with a circular

### Symmetry and a Cooling Component Downstream of the Die.

The meat analogue extrusion system may first pre-process the dough at a dough preparation area. For example, the dough may include multiple ingredients, and the multiple ingredients may require mixing prior to further processing. The mixing may be performed by hand and/or may be performed by a mechanical mixer, for example a blender.

The dough may be placed in a pump, for example a piston pump, of the meat analogue extrusion system. The dough may be placed in the pump by hand, and/or may be automatically transported from the dough preparation area to the pump. The pump may transmit the dough through a line. The line may be connected to an extruder. For example, the line may be connected to a twin screw extruder. In an embodiment of the meat analogue extrusion system, the line is not included, and the pump is connected directly to the extruder.

The extruder, for example a twin screw extruder, may apply a pressure to the dough to move the dough from a side of the extruder with the pump to an opposite side of the extruder. The extruder may additionally or alternatively apply heat to the dough. The extruder may additionally or alternatively be configured with an injection port to inject water and/or another material into the dough as the dough moves though the extruder.

The dough and/or meat analogue may include a raw material. In a preferred embodiment, the raw material is a non-animal substance. Non-limiting examples of suitable non-animal protein substances include pea protein, wheat gluten such as vital wheat gluten, corn protein, for example ground corn or corn gluten, soy protein, for example soybean meal, soy concentrate, or soy isolate, rice protein, for example ground rice or rice gluten, cottonseed, peanut meal, whole eggs, egg albumin, milk proteins, and mixtures thereof. Preferably, the non-meat protein substances are pea protein, wheat gluten, and/or soy protein, and mixtures thereof.

In some embodiments, the protein substance comprises a moisture content of between 50% and 75%, preferably between 55% and 65%.

In some embodiments, the raw material does not comprise a meat and comprises gluten, for example wheat gluten. In some embodiments, the raw material does not comprise a meat and does not comprise any gluten.

The raw material may optionally comprise a flour. If flour is used, the raw material may include protein. Therefore, an ingredient may be used that is both a vegetable protein and a flour. Non-limiting examples of a suitable flour are a starch flour, such as cereal flours, including flours from rice, wheat, corn, barley, and sorghum; root vegetable flours, including flours from potato, cassava, sweet potato, arrowroot, yam, and taro; and other flours, including sago, banana, plantain, and breadfruit flours. A further non-limiting example of a suitable flour is a legume flour, including flours from beans such as

favas, lentils, mung beans, peas, chickpeas, and soybeans.

In some embodiments, the raw material may comprise a fat such as a vegetable fat. A vegetable oil, such as corn oil, sunflower oil, safflower oil, rape seed oil, soy bean oil, olive oil and other oils rich in monounsaturated and polyunsaturated fatty acids, may be used additionally or alternatively.

The raw material may include other components in addition to proteins and flours, for example one or more of a vitamin, a mineral, a preservative, a colorant and a palatant.

It should be understood that various changes and modifications to the examples described here will be apparent to those skilled in the art. Such changes and modifications can be made without departing from the spirit and scope of the present subject matter and without diminishing its intended

advantages. It is therefore intended that such changes and modifications be covered by the appended claims. Further, the present embodiments are thus not to be limited to the precise details of methodology or construction set forth above as such variations and modification are intended to be included within
the scope of the present disclosure. Moreover, unless specifically stated any use of the terms first, second, etc. do not denote any order or importance, but rather the terms first, second, etc. are merely used to distinguish one element from another.

### EXAMPLES

### Example 1

### Difference in Performance Levels of a Classical Coat Hanger Die and the Conic Coat Hanger Die.

A classic coat hanger die was connected to two twin-screw extruders in two separate trials, one set of trials with a Buhler extruder and another with a Clextral extruder.

The two trials were conducted with the same dough formula as described in the following table:

| Ingredients | % wb |
|---|---|
| Pea protein isolate 1 | 12.21 |
| Pea protein isolate 2 | 12.21 |
| Vital wheat gluten | 10.59 |
| Water | 54.76 |
| TVP pea | 7.94 |
| Flavor/seasoning/vitamin | 2.29 |

The temperature of the extruder barrels were increased up to a transition temperature at which the protein blend of the extrudate became a fibrous elastic material to mimic the meat structure and texture.

The dough was prepared in a mixer by mixing the powder blend in water for obtaining a moisture at 54-56% wb. The dough was pumped in the extruder at a given massic flow output.

The flow output was increased progressively and the flow behaviour of the solid elastic extrudate at the exit of the die was observed in order to determine at which flow output value the flow becomes uneven. This flow output value indicated the maximum capacity of the die to process a meat lookalike extrudate material.

The results from the two trials were the same. The maximum flow output for having an even flow in the die was below 20 kg/h and was around 18 kg/h. When the flow output was increased to a value above 20 kg/h, the solid fibrous extrudate flow became uneven because of wall effects of the classical coat hanger die. The flow at each edge of the die became very low and resulted in a complete blockage at the edge of the die with a preferential narrow pathway in the central part of the die.

The same recipe than the one for the classic coat hanger die was used for trials with a Clextral extruder and the conic coat hanger short die of the invention. The same experimental protocol was used. Flow output of the solid fibrous extrudate was increased up to a value for which an even flow was observed (above 50 kg/h and upwards of 150 kg/h) without any observation of a flow distribution problem around the circular slit). The flow was even all along the circular slit at all tested flow output.

The flow output was raised up to 76 kg/h without reaching the limit of the conic die.

In conclusion, the 3-dimensional design and axis symmetry allowed the conic coat hanger to obtain an even flow which may even have been above 100 kg/h (for the tested die) while the 2-dimension of the classic coat hanger die was limited to a value below 20 kg/h.

The tested conic die had an external slit perimeter of 15 cm while the tested classic coat hanger die was upscaled from a slit length of 15 cm to a slit length of 45 cm. Conic dies with an external slit perimeter of 45 cm had an even flow of 300 kg/h.

### Example 2

### Comparison of Commercial and Conic Coat Hanger Die Extrudates

Commercially available meat analogues were compared with meat analogues of the same product type prepared from extrudate manufactured with the conical coat hanger short die (CCHSD). Texture analyses with TAXT+ equipment and sensory analyses with a panel were performed.

For commercial product selection, a search of the Mintel database was conducted for competitor vegan or vegetarian products on sale in Europe since 2017. The products were purchased and kept frozen prior to sensory analysis and texture analysis.

Meat analogues were prepared using wet extrusion and CCHSD. Texture analyses were performed with a TAXT.plus equipment from Stable Micro Systems Ltd, Godalming, United Kingdom. A probe with 1 knife cut through the samples. Standard blades from HDP/KS10 with 1.5 mm beveling at 45° and a 50 kg load cell were used. The measurement parameters were: test speed: 1 mm/s, distance: 30 mm, trigger force: 0.100N.

A total of 10 samples per variant were analyzed, each having a 4×8 cm dimension. Two cutting directions were used for each sample (1-cutting across fibres (transversal) and 2-cutting along fibres (longitudinal)). This allowed to measure whether the fibers were aligned in a preferred direction as seen in a real meat structure. Maximal load force was recorded for each measurement. The average and standard deviation calculated for each sample. The analyzed products were of varying thickness and so the maximum load forces values were normalized by the thickness value, i.e. the maximum load forces values were divided by measured thickness.

The comparison of the maximum load forces values obtained in longitudinal and transversal directions are shown in FIG. 10 for commercial products 1 to 8 and Nestlé products A, B, and C, all of which are the same product type.

Commercial meat analogue products displayed a lower normalized maximal force as compared to Nestle products manufactured with CCHSD, particularly for cutting direction 1 which corresponds to the transversal to the fiber alignment direction in the case of the Nestlé CCHSD samples. The differences between the two direction values is also significantly higher for the product manufactured with CCHSD. These differences can be indicated by the values of the ratio of the maximum force in transversal direction/maximum force in longitudinal direction (ratio D1/D2). The ratio D1/D2 is around 1 for commercial products 1 to 8 indicating no particular fiber orientation and thus no similarity with meat structure. Nestlé products A, B, and C had a ratio of D1/D2 values above 2, indicating a significant fiber orientation which mimics meat structure.

For sensory analysis, an in-house panel consisting of 9 Nestlé employees was recruited to conduct the RATA (Rate All That Apply) methodology on eleven meat analogue products (including commercial samples and Nestlé prototypes). Two training sessions were conducted. During the training sessions, the panelists were introduced to the texture attributes in the ballot (Table 1) and trained using reference samples.

For the RATA procedure, the panelists were asked to tick the sensory descriptors they perceived for describing the individual meat analogue and then to rate the intensity of the given attribute using five-point category scale (“slightly”, “moderately”, “much”, “very much”, “extremely”). However, if they did not perceive the sensory attribute, they were instructed to skip the attribute, thus leaving the intensity box empty. Fresh water was used for palate cleansing.

In order to determine which samples were significantly different from each other and on which attribute(s), a two-way ANOVA was applied. The sample was fixed and the panelist was a random factor. The data was treated as continuous data. A non-selected attribute was treated equivalent to “not perceived” and assigned as intensity=0. ANOVA indicated significant differences between vegan meat analogues evaluated in the present study, and so Fisher's Least Significant Difference (LSD) was then calculated to determine the significance of the difference between any pair of samples. A 95% confidence level was applied to these statistical tests.

The attributes which were contributing the most to differentiating the samples was determined. The range/LSD is an index enabling to rank the attributes according to their discriminating power within a given sample set, the range being the difference between the largest and smallest

sensory scores given by the panel for the whole sample set and for a given attribute. The higher the Range/LSD index for a given attribute, the more discriminant the attribute was for a given sample subset. In the context of the present study, the sensory scores for the texture attributes showing the highest
Range/LSD index (>3) are detailed.

| Attribute name | Definition | − | + |
|---|---|---|---|
| Initial firmness | Resistance when chewing | Soft | Very |
| | between molars for the | | Firm |
| | first chew | | |
| Firm | Overall resistance when | Soft | Very |
| | chewing between molars for | | Firm |
| | the overall evaluation | | |
| Compact | Dense and heavy texture | Aerated | Dense |
| | resuting from a lack | | |
| | of the air in the product. | | |
| | Opposite: Aerated | | |
| Chewy | Number of chews until the | Melting | Chewy |
| | product is ready for | | |
| | swallowing | | |
| Rubbery | Recovery of food (particle) | | Springy/ |
| | shape after repeated | | Elastic |
| | compression between the molars | | |
| Fibrous | Amount of long fibers | Not | |
| | perceived during consumption | (Dough) | |

The data from sensory analysis allowed the products to be classified in groups. Group 1 corresponds to the Nestlé CCHSD products and are characterized by having significantly greater fibrous texture and less compact sensation. Commercial products in Group 2 have less fibrous texture and

average properties for other attributes, while commercial products in group 3 are also less fibrous but more firm, compact and moist as shown below.

### Example 3

Performance of a System Comprising a Conic Coat Hanger Die with a Cooling Chamber Downstream of the Die

Trials were conducted to produce samples using a conic coat hanger die, with and without a cooling chamber downstream of the die.

Plant-based raw materials soy/gluten or pea/gluten were used with a total protein content of 45-35%. Protein ratio between soy and gluten or pea and gluten is 1.3-2.1, with a moisture content between 55-65%.

### Process Data:

### Screw Section of Extrusion Process:

Twin screw extrusion
Use of powder feeders for soy protein-based recipe+superheated water (90-105° C.)
Use of dough feeder for pea protein-based recipe
Use of a high shear screw configuration
Increase of extrusion temperatures up to 165° C. until 70% of extruder length, cooling of protein matrix in the last two extruder barrels (70-100% of extruder length)
Protein matrix entering the conic coat hanger die with material temperatures of 105-135° C.

### Cooling Chamber Section of Extrusion Process, Downstream of Die:

Different gap sizes of 3.3 and 4.8 mm were tested leading to a different product thickness. Gap size of 3.3 mm leads to a product thickness of 4-4.5 mm and gap size of 4.8 mm leads to a product thickness of 5-6 mm. Gap size influences shear rate in the conical part of the conic coat hanger die, and thus the fiber formation and fiber alignment. Higher shear rates results in smaller gap sizes.

The trial results are shown in Tables 1 and 2. In Table 1, samples 1 to 3 do not use a cooling chamber downstream of the die. Samples 4 to 9 are using the cooling chamber. With the model, only inlet conditions of meat dough and coolant temperatures are used. The temperature of the meat dough at the exit is compared between model and experimental results. It can be seen that by using the cooling chamber after the die, the temperature of the extrudate can be kept well below the vaporization temperature of water. The results for with and without the downstream cooling chamber for the same conditions of the mass flow rates and inlet temperatures of meat dough and coolants are can be compared for samples 4 and 10 [simulated for conditions without a cooling chamber]. It can be seen that in the absence of downstream cooling chamber, the extrudate temperature is close to 100° C. compared to 92° C. with the cooling chamber.

With the cooling chamber, the temperature of the extrudate is reduced well below the vaporization temperature when it exits the complete assembly. This temperature reduction is observed in all the different extrusion parameters demonstrating the efficiency of the channel extension device. At flow throughput of 200 kg/h and without the cooling extension the temperature of the extrudate at the die exit would reach value close to 100° C. with vapor flashes and flow instabilities.

It was observed that use of the cooling chamber downstream of the die results in a more continuous, cohesive, stable carpet of extrudate. This means that post processing, such as cutting, stamping or assembling, is easier and results in better shaping and less process losses. This stable carpet is also more useful for producing different product formats, such as nuggets, schnitzel and tender, 2D chicken breast formats. This also allows greater usability of extrudate extruded through a greater gap size at the die exit between the core and insert, which allows increased product thickness.

As described above for Example 2, sensory analysis was conducted for the extrudate obtained using a cooling chamber downstream of the die. Table 2 describes the improved results achieved in terms of a stronger texture and a denser, more stable composition.

In addition to the above measurements, dynamic rheological properties were measured in a pressure cell equipped in an oscillatory rheometer (MCR702, Anton Paar) for Soy Tradcon/Gluten (in the form of a single chicken breast). A pressure of 50 bars was used to avoid water evaporation, thus allowing the characterization of structural and state transitions at high temperatures.

The complex viscosity, the mechanical viscoelastic moduli (G′, G″) and their ratio (structure parameter tan d=G″/G′) at low deformation and reasonable frequency (stress of 100 Pa and frequency 1 Hz) were measured using a parallel plate geometry (diameter: 20 mm). They were measured during the heating (20° C.-180° C.-20° C.) at a heating rate of 2° C./min.”

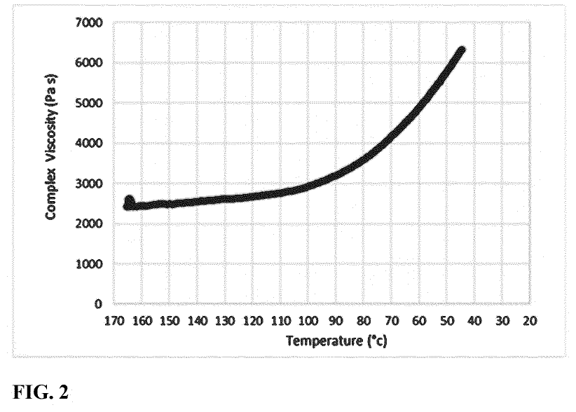

FIG. 2 illustrates that cooling the extrudate from 100° C. to 80° C. results in a viscosity increase from 2900 to 3500 Pa·s and in better mechanical resistance.

| | | | | | | Conic die | | | Conic die | | | Cooling | | | | |
|---|---|---|---|---|---|---|---|---|---|---|---|---|---|---|---|---|
| | | | Bypass cooling | | | inner cooling | | | outer cooling | | | temperatures | | | Temperature | |
| | Mass | End plate | temperatures | | | temperatures | | | temperatures | | | downstream of die | | | of dough | |
| | flow of | dough | (° C.) | | | (° C.) | | | (° C.) at | | | (° C.) | | | at exit | |
| | dough | temperature | | | Q | | | Q | | | Q | | | Q | (° C.) | |
| Sample | (kg/h) | (° C.) | In | Out | kg/h | In | Out | l/h | In | Out | l/h | In | Out | l/h | Ex | model |
| 1 | 175 | 113 | 69 | 69.1 | 1300 | 28.5 | 29.8 | 4500 | 24.7 | 26.2 | 4500 | | | | 93.5 | 94.1 |
| 2 | 175 | 115 | 68.7 | 68.8 | 1300 | 27.8 | 29. | 4500 | 23.2 | 24.4 | 4500 | | | | 94 | 95.5 |
| 3 | 175 | 115 | 69 | 69.1 | 1300 | 27.1 | 28.2 | 4500 | 29.2 | 30.3 | 4500 | | | | 94 | 96.1 |
| 4 | 200 | 118 | 79.1 | 79.2 | 1300 | 21.3 | 22.6 | 4500 | 22.1 | 23.3 | 4500 | 24.4 | 25.7 | 4500 | 92 | 91.3 |
| 5 | 200 | 110 | 53.5 | 53.6 | 1300 | 15.3 | 16.6 | 4500 | 16.9 | 18.4 | 4500 | 21.6 | 22.9 | 4500 | 89.1 | 87.9 |
| 6 | 200 | 113 | 53.8 | 53.9 | 1300 | 14.8 | 16.3 | 4500 | 16.2 | 17.7 | 4500 | 21.3 | 23.3 | 4500 | 90.4 | 90.1 |
| 7 | 175 | 123 | 58.6 | 58.8 | 1300 | 33.4 | 35.5 | 1500 | 38.7 | 40.6 | 1500 | 43.4 | 44.3 | 1500 | 85 | 84.36 |
| 8 | 175 | 124 | 38.6 | 39.0 | 1300 | 34.8 | 36.6 | 1500 | 25.8 | 27.8 | 1500 | 35.8 | 36.6 | 1500 | 85 | 81.9 |
| 9 | 225 | 123 | 78.7 | 79 | 1300 | 60.4 | 61.9 | 4500 | 52.7 | 54.5 | 4500 | 51.6 | 52.7 | 4500 | 93.4 | 97.1 |
| 10 | 200 | 118 | 79.1 | 79.2 | 1300 | 21.3 | 22.6 | 4500 | 22.1 | 23.3 | 4500 | | | | | 99.46 |

| | | Gap | | | | | | | | |
|---|---|---|---|---|---|---|---|---|---|---|
| | | size | Cooling | | | | | | | |
| | Sample | conical | Chamber, | Breaker | | Tasting | | Tearing | | Chewing/ |
| Die | code | part | downstream | plate | Preparation | results | Texture | apart | Fibers | mouthfeel |
| Conic | C | 3.3 | w/o | w/o | Fillet | like glued | mushy, | fragile, | more, | a bit |
| die | | mm | chamber | breaker | pieces, | together, | soft, | good | smaller | mushy, |
| | | | | plate | pan | like mix | brittle | tearing | fibers | brittle, |
| | | | | | fried | & formed | | apart | | soft |
| | A | 4.8 | Downstream | w/o | | overall | chewy, | good | | chewy, |
| | | mm | cooling | breaker | | big | chicken leg | tearing | | tender, |
| | | | chamber | plate | | difference | like texture, | apart | | soft |
| | | | 4.8 mm | | | to sample | firmer than | | | |
| | | | | | | B | C, rubbery, | | | |
| | | | | | | | good meaty | | | |
| | | | | | | | bite | | | |
| | 1 | 3.3 | Downstream | w/o | | | firmer than | | more, | softest, |
| | | mm | cooling | breaker | | | C, rubbery, | | longer | soft |
| | | | chamber | plate | | | most tender, | | fibers, | pleasant |
| | | | 3.3 mm | | | | soft, good | | most | texture |
| | | | | | | | meaty bite | | fibers | |
| | 2 | 4.8 | Downstream | Breaker | | | firmer than | | less | chewy, |
| | | mm | cooling | plate 1 | | | C, rubbery, | | fibers | tender, |
| | | | chamber | | | | tender, soft, | | | soft |
| | | | 4.8 mm | | | | good meaty | | | |
| | | | | | | | bite | | | |
| | 5 | 4.8 | Downstream | Breaker | | | similar to 2, | | less | tender, |
| | | mm | cooling | plate 2 | | | bit softer, | | fibers | soft |
| | | | chamber | | | | chewy, | | | |
| | | | 4.8 mm | | | | rubbery | | | |
| Long | B | — | — | — | technical | | firmer, | tearing | the | firmer, |
| die | | | | | pieces, pan | | dense, less | apart | least | tender, |
| | | | | | fried | | fibrous | acceptable, | fibrous | least |
| | | | | | | | | product | | fibrous |
| | | | | | | | | firmer and | | |
| | | | | | | | | less | | |
| | | | | | | | | fibrous | | |

1. A system for making a meat analogue comprising protein, said system comprising:
i) a die comprising an insert; a core; and a flow path; wherein the flow path is defined by the insert and the core; and
ii) a cooling component comprising a cooling chamber, wherein said cooling component is downstream of the die and the flow path passes through the cooling chamber.

2. The system of claim 1, wherein the cooling chamber comprises a double-jacket structure providing a flow path through the cooling chamber.

3. The system of claim 1, wherein the cooling chamber comprises helical or cylindrical cavities in which cooling media is located.

4. The system of claim 1, wherein the die length is less than the die width and is of the coat-hanger type.

5. The system of claim 1, wherein the die comprises a die exit, formed by a gap between the core and the insert, and wherein the cooling chamber is downstream of the die exit.

6. The system of claim 1, wherein the core comprises a cylindrical section and a summit end, and the die comprises an expansion chamber located between the summit end and the die exit; and the cooling chamber is downstream of the expansion chamber.

7. The system of claim 5, wherein die exit is circular.

8. The system of claim 5, wherein the ratio of the gap size of the die exit to the gap size of the cooling component entry is 1:2 or less.

9. The system of claim 1, further comprising a transition plate and a breaker plate upstream of the die.

10. A method of making a meat analogue comprising a protein, the method comprising:
applying heat and/or pressure to a protein dough in an extruder and passing the dough through a system for making a meat analogue comprising protein, said system comprising:
i) a die comprising an insert; a core; and a flow path; wherein the flow path is defined by the insert and the core; and
ii) a cooling component comprising a cooling chamber, wherein said cooling component is downstream of the die and the flow path passes through the cooling chamber, wherein the dough passes through the flow path.

11. The method of claim 10, wherein a) the dough reaches a temperature of between 110° C. and 170° C. in the extruder, b) the temperature of the dough decreases in the die, and c) further decreases to a temperature of between 10° C. and 60° C. in the cooling component.

12. The method of according to claim 10, wherein the meat analogue comprises fibres which are formed in a substantially perpendicular direction to the flow path of the die.

13. An apparatus comprising: i) a die comprising an insert; a core; and a flow path; wherein the flow path is defined by the insert and the core; and ii) a cooling component comprising a cooling chamber, wherein said cooling component is downstream of the die and the flow path passes through the cooling chamber.

14. The apparatus of claim 13, wherein the cooling chamber comprises a double-jacket structure providing a flow path through the cooling chamber.

15. The apparatus of claim 13, wherein the cooling chamber comprises helical or cylindrical cavities in which cooling media is located.

16. The apparatus of claim 13, wherein the die length is less than the die width and is of the coat-hanger type.

17. The apparatus of claim 13, wherein the die comprises a die exit, formed by a gap between the core and the insert, and wherein the cooling chamber is downstream of the die exit.

18. The apparatus of claim 13, wherein the core comprises a cylindrical section and a summit end, and the die comprises an expansion chamber located between the summit end and the die exit and the cooling chamber is downstream of the expansion chamber.

19. The apparatus of claim 17, wherein die exit is circular.

20. The system of claim 17, wherein the ratio of the gap size of the die exit to the gap size of the cooling component entry is 1:2 or less.
